(19) United States
(12) Patent Application Publication
(10) Pub. No.: US 2007/0237872 A1
(43) Pub. Date: Oct. 11, 2007

(54) Three-Dimensional Food Products

(75) Inventor: Robert Chatel, Hoffman Estates, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: The Quaker Oats Company, Chicago, IL (US)

(21) Appl. No.: 11/697,956

(22) Filed: Apr. 9, 2007

Related U.S. Application Data
(60) Provisional application No. 60/790,714, filed on Apr. 10, 2006.

(51) Int. Cl. A21D 10/00

(52) U.S. Cl. 426/549

(57) ABSTRACT

A process of forming 3-dimensional food products, such as cereal products, includes providing cooked dough that is injected into a mold to form a 3-dimensional piece of food product. The shape of the 3-dimensional food product is controlled by the configuration of the interior surfaces of the mold. The mold may be a hot mold or a cold mold. The use of a hot mold causes the dough in the mold to expand, forming an expanded 3-dimensional food product. The use of a cold mold forms an unexpanded 3-dimensional food product.

### CROSS-REFERENCE TO RELATED APPLICATION

This application claims benefit to U.S. Provisional Application Ser. No. 60/790,714 filed Apr. 10, 2006.

### FIELD OF THE INVENTION

The present invention relates generally to food products, and more particularly to methods and techniques to form 3-dimensional food products, such as cereal food products.

### BACKGROUND OF THE INVENTION

Various techniques are used to prepare food products such as cereal. For example, conventional direct expansion extrusion may be used to form cereal pieces. By way of illustration, direct expansion extrusion involves cooking and forming cereal dough in an extruder. The cooked cereal dough is then extracted from the extruder through a die, creating an elongated or rope-shaped dough having a 2-dimensional cross section defined by the die. By cutting the rope-shaped dough, 3-dimensional pieces may be formed. The thickness of the pieces may be controlled by the rate at which the rope is cut into pieces.

A disadvantage using conventional direct expansion extrusion techniques to make cereal, for example, is the inability to control the third dimension of the cereal pieces beyond their nominal, cut length. Another disadvantage with this extrusion technique is that upon exiting the die, control over the expansion of the dough in all directions and swell in the radial direction of the dough can be difficult.

Consequently, there exists a need to form 3-dimensional food products, such as cereal, whose shape can be effectively controlled. The present invention is directed at providing such a process for forming a 3-dimensional food product.

### SUMMARY OF THE INVENTION

The invention relates to forming 3-dimensional food products. One embodiment of the invention relates to a process for forming a 3-dimensional cereal food product. The exemplary process includes providing cooked cereal dough that is injected into a mold to form a 3-dimensional piece of cereal food product. The shape of the 3-dimensional cereal product is controlled by the configuration of the interior surfaces of the mold. The exemplary mold may be a hot mold or a cold mold. The use of a hot mold causes the dough in the mold to expand, forming an expanded 3-dimensional cereal food product. The use of a cold mold forms an unexpanded 3-dimensional cereal food product.

Other features and advantages of the invention will become apparent to those skilled in the art upon review of the following detailed description, claims and drawings in which like numerals are used to designate like features.

### BRIEF DESCRIPTION OF DRAWINGS

FIG. 1 shows an exemplary process in accordance with one embodiment of the invention.

FIG. 2 shows in schematic form an extruder for preparing and cooking dough used to form a 3-dimensional food product; and

FIG. 3 shows an exemplary integrated injection molding compounding system for forming a 3-dimensional food product in accordance with one embodiment of the invention.

### DETAILED DESCRIPTION OF THE EMBODIMENTS

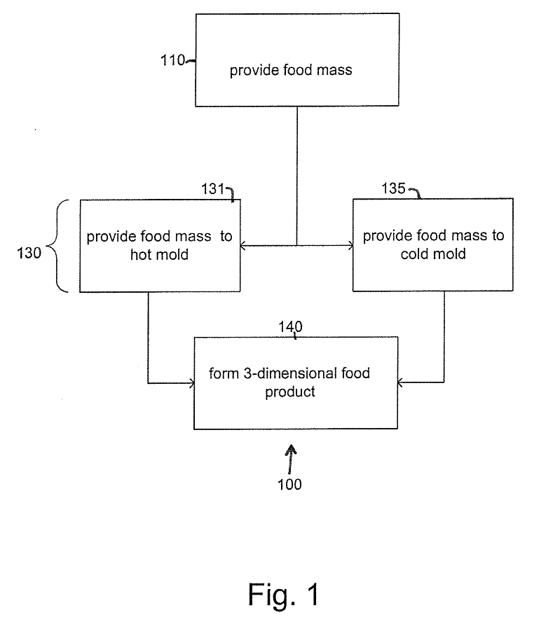

The present invention may be embodied in many forms. FIG. 1 shows a process 100 for forming a 3-dimensional food product in accordance with one embodiment of the invention. The process described herein may be applied to produce numerous food products, including without limitation cereal food products. Referring to FIG. 1, at step 110, a food mass may be provided from which a 3-dimensional food product may be formed. In one embodiment, the food mass may comprise a dough, such as a cereal dough. The dough may be cooked or uncooked. If the dough is cereal dough, it may include cereal grain, such as oat, wheat, corn (maize), rice, barley, millet, sorghum (milo), rye, triticale, teff, wild rice, spelt, buckwheat, amaranth, quinoa, kaniwa, cockscomb or a combination thereof. In one embodiment, the cereal dough may comprise a high fat content. In another embodiment, the cereal dough may comprise whole oat. The cereal dough may be formed from a pre-mix that includes cereal flour. Other types of grains or pre-mix may also be used. The pre-mix flour may be formed from milled grain, which may further be whole or refined grain, or a combination thereof.

As is understood, to form the dough, the flour is mixed with liquid, such as water. Other liquids, for example, fruit juices may also be used. The dough, in one embodiment, may contain at least about 50 weight % flour and 30-35 weight % liquid of the total weight of the dough. In one embodiment, the dough may comprise about 55 to 70 weight % flour and about 25-40 weight % liquid. In yet another embodiment, the dough may comprise about 60 weight % flour and 35 weight % liquid. As is also understood, additional ingredients may be added to the dough for nutrition purposes as well as for flavoring. For example, up to 20 weight % sugar or sweetener, up to 2 weight % salt as well as vitamins and minerals may be added. It should be understood that other compositional percentages may be used and other ingredients may be added, depending on the desired texture, materials used and flavor.

If the dough is cooked dough, the dough typically will be cooked at a temperature range of about 240 to 280° F., though the dough may be cooked at other temperatures. It should be understood however that the cooking parameters, such as time, temperature, and pressure, may vary depending on the application, for example, the types of ingredients used, the mass of the product, and the desired end product. Cooking the dough will gelatinize the starch in the cereal, transforming the dough into a viscoelastic material.

Various techniques may be used to prepare and cook the dough. For example, the dough can be prepared and cooked using batch processing. Alternatively, the dough can be prepared or cooked in an extruder. A single extruder or separate extruders can be used to prepare and cook the dough. The use of a mixer to prepare the dough and an extruder to cook the dough may also be used.

In one embodiment of the invention, the dough may be prepared and cooked in an extruder. Various types of extruders may be used. For example, the extruder may include venting to allow evaporative cooling for control of the final moisture and temperature of the dough. Employing separate extruders which are configured in series for forming and cooking the dough may also be used for venting purposes. Generally, the time, temperature, and pressure parameters of the cooking process will vary to suit a particular application, depending on the types of ingredients used, the mass of the product, and the desired end product.

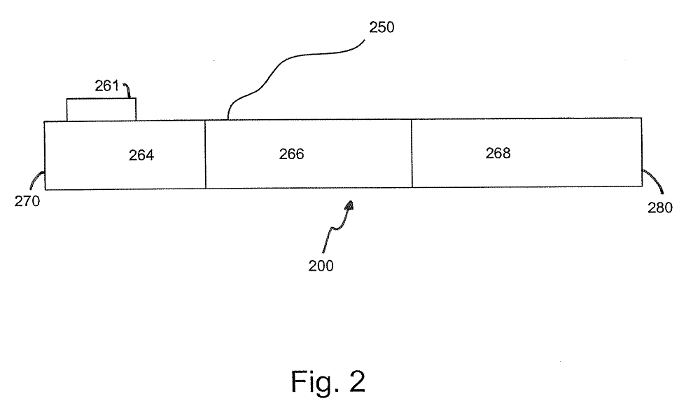

Referring to FIG. 2 there is illustrated a schematic depiction of an extruder 200 that may be used in preparing and cooking the dough in accordance with an embodiment of the invention. As shown, the extruder 200 may comprise a barrel or tubular structure 250 having upstream and downstream ends 270 and 280, respectively. The extruder may include various functional zones. For example, the extruder may include a mixing zone 264 at the upstream end 270 followed by a heating or cooking zone 266 followed by a cooling zone 268. The food mass is moved from the extruder inlet to the extruder exit from one contiguous zone to another zone within the barrel 250.

The following describes the operation of an extruder, such as extruder 200. During operation, the screws of the extruder are turned continuously. Pre-mix may be fed into the mixing zone 264 through feeder 261 located at the upstream end 270 of the extruder 200. Moisture may be added to the pre-mix in the mixing zone 264. The moisture may be added in the form of steam or water. Direct injection of water or other types of liquids into the mixing zone may be employed. As the screw turns, the pre-mix and moisture are mixed in the mixing zone 264 to form the dough. Other ingredients, such as flavoring, vitamins, minerals, coloring, and fiber may also be added at this stage to achieve the desired taste, texture, and nutritional characteristics.

The dough is then passed into the heating zone 266 for cooking. The applied heat may be generated using various techniques, such as friction, hot water, steam, heat transfer or a combination thereof. Moisture or liquid may be added to the dough during cooking. The moisture or liquid added to the process may be measured and controlled to achieve, for example, the desired viscosity of the dough.

The cooked dough is then discharged from the extruder 200. If necessary, a cooling zone 268 may be provided to adjust the temperature of the dough before discharging it from the extruder 200.

Referring back to FIG. 1, the dough may be injected into a mold at step 130. The pressure employed should be adequate to inject the dough into the mold. The pressure employed may depend on the viscosity of the dough—higher dough moisture content and/or higher dough temperature may cause the dough to be less viscous, allowing for the use of lower pressures. Conversely, lower dough moisture content and/or lower dough temperature may result in the dough being more viscous, which may require higher pressures to be used.

In one embodiment of the invention, the mold may comprise a hot mold 131. The use of a hot mold 131 causes the dough in the mold to expand, forming an expanded 3-dimensional food product. The temperature and moisture of the mold may affect the expansion and texture of the food product. For example, the higher the temperature, the greater the expansion from the steam generated when the pressure drops. In an exemplary embodiment, the temperature of the dough in the hot mold 131 may be about 240 to 300° F. It should be understood that the moisture content of the dough dictates the size of the food product created during expansion.

In an alternative embodiment of the invention, the dough may be injected into a cold mold 135. The use of a cold mold forms an unexpanded 3-dimensional food product. In one embodiment, the temperature of the dough in the cold mold 135 may be below the boiling temperature of water. In an exemplary embodiment of the invention, the dough in the cold mold 135 may be about 190 to 205° F.

With either the hot mold or cold mold, the food product formed, such as cereal, may define any one of numerous 3-dimensional configurations depending on the interior shape and configuration of the mold. For example, the mold may define interior contours, ridges, surfaces or other configurations that would create a 3-dimensional shape having a textured surface for the food product.

In one embodiment, the process of forming the 3-dimensional food product may be performed in an integrated system, such as an injection molding compounder. Many possible injection molding compounders may be used with the invention. For example, an injection molding compounder manufactured by Krauss-Maffei may be used. It should be understood that forming the 3-dimensional food product may be accomplished using non-integrated systems, that is, systems using individual components.

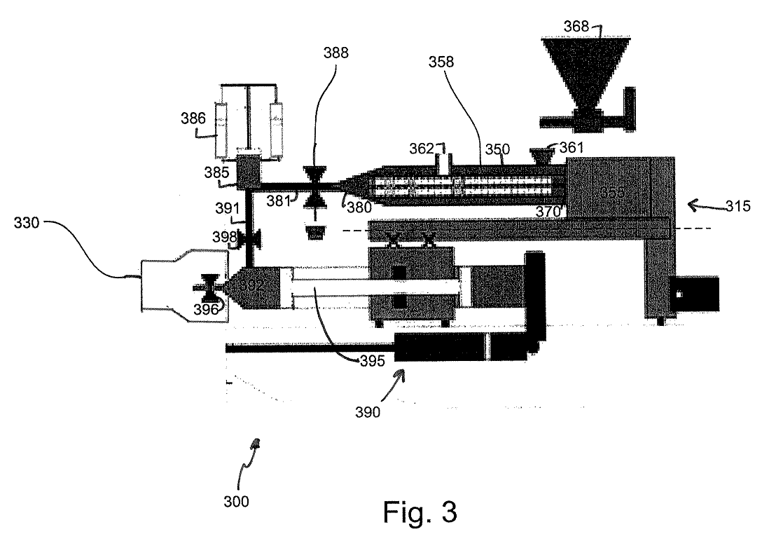

FIG. 3 shows an exemplary injection molding compounding system 300 that may be used with the invention for forming 3-dimensional food products. While many possible injection molding compounders may be used with the principles of the invention, an exemplary injection molding compounding unit is described in, for example, U.S. Pat. No. 6,854,968.

As shown in FIG. 3, the system 300 may comprise an extruding unit 315 coupled to an injection molding unit 390. The extruding unit 315 may include an extruder. In one embodiment, the extruder may comprise a barrel 350 with upstream and downstream ends 370 and 380, respectively. One or more screws 358 may be located within the barrel 350 and may be turned by a drive unit 355. At least one feeder 368 may be provided at the upstream end 370 of the barrel. One or more additional feeders may be provided towards the downstream end 380 of the barrel 350. A dry solids feeder 368 may be coupled to the extruder via the feed throat 361 to supply ingredients to the extruder.

A reservoir 385 may be coupled to the extruder and more specifically to the downstream end 380 of the barrel 350 by a reservoir conduit 381. The volume of the reservoir may be controlled by a reservoir controller 386. The controller 386 may include, for example, twin hydraulic cylinders which control the position of a plunger to determine the volume of the reservoir 385. A pressure control valve 388 may also be provided in the conduit 381. The pressure control valve 388 may be used to control the pressure in the reservoir 385 and the extruding unit 315. For example, if the pressure is too high in the extruding unit 315, the pressure control valve 388 may be opened to reduce the pressure in the extruding unit 315.

The extruding unit 315 may be coupled to the injection molding unit 390 by an injection conduit 391. The conduit 391 may be coupled to the reservoir 385 of the extruding unit at one end while the other end may be coupled to a melt chamber 392 of the injection molding unit 390. A melt chamber shut-off valve 398 may be provided in the injection conduit 391 to control the filling of the melt chamber with the processing material, such as dough. A mold control valve 396 may be provided at the injection molding unit exit end to control the material delivered to an exemplary mold 330. As described above, the mold 330 may define a hot mold or a cold mold, or possibly a combination of both, and may define numerous mold configurations depending on the desired 3-dimensional food product shape. It should be understood therefore that the exemplary mold 330 is simply illustrative of the numerous possible molds or mold configurations. The various valves and components described above may be controlled by a control system to achieve the desired processing parameters.

In operation, ingredients are deposited into the extruding unit through the feed throat 361 via feeder 368. In one embodiment, cereal flour may be fed into the extruding unit. Other dry powder ingredients, such as starches and fibers, to name a few, may be added to the extruding unit via additional feeders through feed throat 361. Water, as well as other liquids such as flavoring, coloring, and oil may be added via a pump through an injection port located immediately downstream of the feed throat 361. Moreover, some or all of the additional ingredients may be subsequently added through an additional feeder provided toward the downstream end 380 of the barrel 350. For example, ingredients which are sensitive to temperature may be added in the additional feeder, which is attached nearer the downstream end 380 of the barrel 350.

The cereal flour that may include whole oat, for example, and the moisture and other ingredients placed in the barrel 350 of the extruder may be mixed together. The screws 358 in this zone are designed to mix the flour, moisture and ingredients together, forming a wet flour mixture in the barrel 350. The wet flour mixture, for example, may comprise in one exemplary embodiment, at least about 50 weight % of whole oat flour and about 30-35 weight % of water.

The wet flour mixture may then be transformed into cooked dough by the addition of heat in the extruder. The cooked dough may be discharged from the barrel end 380 and may fill the reservoir 385 via the reservoir conduit 381. The reservoir 385 temporarily stores the dough. Since the extruder continuously discharges dough, the volume of the reservoir may be adjusted accordingly. Pressure control valve 388 may be controlled to ensure that pressure within the extruding unit 315 is at the desired level. The pressure level, for example, may be maintained at about 750-1000 psi. Other pressures may also be maintained, depending on the application.

The flow of dough from the reservoir 385 to the melt chamber 392 of the injection unit 390 via melt chamber conduit 391 may be controlled by the melt chamber shut-off valve 398. For example, when the melt chamber 392 is filled to the desired level, the shut-off valve 398 is closed, preventing additional dough from entering the chamber 392.

Once in the melt chamber 392, the dough may be injected into the exemplary mold 330 by opening the mold valve 396. The injection may be accomplished by an injection ram 395 which pushes the dough from the melt chamber 392 past the valve 396 and into the mold 330. Once the dough is injected into the mold 330, the mold 330 will form a 3-dimensional food product, such as a cereal piece. The amount of dough entering the mold 330 may be controlled by the duration that the mold valve 396 remains opened. As such, the shape of the 3-dimensional food product may be precisely controlled by the interior surfaces of the mold 330 as well as the mold valve, unlike conventional extruding and cutting processes. Moreover, depending on whether the mold 330 is hot or cold, the food product may be expanded or unexpanded. It should be understood that the mold 330 may be designed and configured to form a single food product or a plurality of food products.

As illustrated, the use of an integrated system which combines a continuous extrusion with a semi-continuous injection process may result in the flow of dough to be intermittently interrupted. Interrupting the flow may cause the dough to harden thereby increasing its viscosity and potentially creating blockages. To alleviate hardening of the dough, a high fat content cereal grain, such as oat, may be incorporated into the dough. The use of dough having a high fat content may also reduce friction in the conduits, enabling injection at lower pressures. Additionally, with the high fat content, the reservoir and pressure valves may facilitate the production of a more homogenous dough from the extruder, thus improving dough stability.

While the invention has been particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

What is claimed is:

1. A process for forming a cereal food product comprising:
providing cooked cereal dough; and
injecting the cereal dough into a mold to form a 3-dimensional piece of the cereal food product, wherein injecting the dough into the mold enables the shape of the 3-dimensional cereal food product to be controlled by the interior surfaces of the mold.

2. The process of claim 1 wherein the cereal dough comprises whole oat.

3. The process of claim 1 wherein cereal dough comprises a high fat content.

4. The process of claim 1 wherein providing the cooked cereal dough comprises cooking the cereal dough using an extrusion process.

5. The process of claim 1 wherein injecting the cooked dough into the mold comprises injecting the cooked dough into a hot mold to form an expanded 3-dimensional cereal food product.

6. The process of claim 1 wherein injecting the cooked dough into the mold comprises injecting the cooked dough into a cold mold to form an un-expanded 3-dimensional cereal food product.

7. The process of claim 1 wherein injecting the cooked dough includes using a injection mold unit.

8. The process of claim 7 wherein the injection mold unit is coupled to an extrusion unit to form the 3-dimensional cereal food product.

9. The process of claim 8 wherein the extrusion unit provides the cooked dough for injecting into the mold via the injection mold unit.

10. The process of claim 9 wherein injecting the cooked dough into the mold comprises injecting the cooked dough into a hot mold to form an expanded 3-dimensional cereal food product.

11. The process of claim 9 wherein injecting the cooked dough into the mold comprises injecting the cooked dough into a cold mold to form an un-expanded 3-dimensional cereal food product.

12. A method of forming a food product using an integrated injection mold unit and extrusion unit, the method comprising:
providing dough ingredients in the extrusion unit;
mixing and cooking the dough ingredients in the extrusion unit;
extruding the cooked dough into the injection mold unit via a conduit, and
injecting the cooked dough into a mold to form a 3-dimensional food product, wherein injecting the dough into the mold enables the shape of the 3-dimensional food product to be controlled by the interior surfaces of the mold.

13. The method of claim 12 wherein the extrusion unit includes a pressure control valve and a reservoir.

14. The method of claim 12 wherein injecting the cooked dough into the mold comprises injecting the cooked dough into a hot mold to form an expanded 3-dimensional food product.

15. The method of claim 12 wherein injecting the cooked dough into the mold comprises injecting the cooked dough into a cold mold to form an un-expanded 3-dimensional food product.

16. The method of claim 12 wherein the injection mold unit includes a melt chamber for receiving the cooked dough.

17. The method of claim 16 wherein the injection mold unit includes an injection ram for pushing the cooked dough from the melt chamber into the mold.

18. The method of claim 17 wherein the injection mold unit includes a melt chamber shut-off valve to control the flow of cooked dough into the melt chamber.

19. The method of claim 18 wherein injecting the cooked dough into the mold comprises injecting the cooked dough into a hot mold to form an expanded 3-dimensional food product, wherein the hot mold has a temperature in the range of approximately 240 to 300 degrees Fahrenheit.

20. The method of claim 18 wherein injecting the cooked dough into the mold comprises injecting the cooked dough into a cold mold to form an un-expanded 3-dimensional food product, wherein the cold mold has a temperature in the range of approximately 190 to 205 degrees Fahrenheit.
